(19) United States
(12) Patent Application Publication
(10) Pub. No.: US 2013/0071185 A1
(43) Pub. Date: Mar. 21, 2013

(54) Bank Protection Structure with Shape of Hollow Circular Truncated Cone

(71) Applicants: Zhilin Wei, Wuha (CN); Jiayi Wang, Wuha (CN); Wei Xu, Wuha (CN); Shasha Gan, Wuha (CN); Zhenghu Tang, Wuha (CN); Junxing Wang, Wuha (CN); Dahong Chen, Wuha (CN); Caihua Zhan, Wuha (CN); Jinlong Wang, Wuha (CN); Lianjun Zhao, Zhengzhou (CN); Guoming Gao, Zhengzhou (CN); Zhenhua Cui, Wuha (CN); Songwei Chen, Wuha (CN); Ruyin Zhang, Zhong Mou (CN); Xinnai Jing, Zhengzhou (CN); Xin Li, Zhengzhou (CH); Tao Ma, Zhengzhou (CN); Kai Zhang, Wuha (CN)

(72) Inventors: Zhilin Wei, Wuha (CN); Jiayi Wang, Wuha (CN); Wei Xu, Wuha (CN); Shasha Gan, Wuha (CN); Zhenghu Tang, Wuha (CN); Junxing Wang, Wuha (CN); Dahong Chen, Wuha (CN); Caihua Zhan, Wuha (CN); Jinlong Wang, Wuha (CN); Lianjun Zhao, Zhengzhou (CN); Guoming Gao, Zhengzhou (CN); Zhenhua Cui, Wuha (CN); Songwei Chen, Wuha (CN); Ruyin Zhang, Zhong Mou (CN); Xinnai Jing, Zhengzhou (CN); Xin Li, Zhengzhou (CH); Tao Ma, Zhengzhou (CN); Kai Zhang, Wuha (CN)

(21) Appl. No.: 13/508,530

(22) PCT Filed: Jun. 28, 2011
(86) PCT No.: PCT/CN2011/076536

§ 371 Date: May 7, 2012

(30) Foreign Application Priority Data
Jul. 6, 2010 (CN) 201010222882.8

(51) Int. Cl. E02B 3/04; E02B 3/26; F16F 7/00

(52) U.S. Cl. CPC E02B 3/04; F16F 7/00; E02B 3/26
USPC 405/15; 267/141; 267/140

(57) ABSTRACT

The present invention discloses a concrete structure used for bank protection and scour prevention of river bank and coast. Its construct is a hollow circular truncated cone and concrete flat plates are plugged on the hollow circular truncated cone. By tearing, dispersing and stirring up water flow, the energy of local water flow is dissipated, and the scouring strength of the water flow is weakened, achieving the aim of scour prevention and bank protection. It has good mechanical property, not easy to be destroyed, has good stability in water and big overhead rate, and can save materials. Compared to previous various structures for scour prevention, the present invention has better effects of energy dissipation and scour prevention. It not only can be used in bank protection and scour prevention, but also can be used for supplementary energy dissipation when plugging and closure.

### FIELD OF THE INVENTION

The present invention belongs to hydraulic engineering technology field, and more particularly, to a bank protection structure used for river bank, lakeshore and coast.

### BACKGROUND OF THE INVENTION

Flood is one of the largest natural disasters on human, river bank (coast) erosion and collapse is one of the most important direct causes of the cause of flooding, and thus bank protection and scour prevention is one of the most important elements of flood control. The oldest way of bank protection is riprap, because the stones can be taken from nature, low cost, operation is extremely simple, and so, until now is still the most widely used for bank protection. The stones can be seen as an “entity” material for bank protection, when water flow acts on the stones of the entity, flow around and scouring often occur, making it sunk into the mud of riverbed, and thus when a strong water flow erosion occurs, the scour prevention of stones is less effective. The “water permeable” protective material (called the “broom” in many parts of China), invented by ancient people, made of firewood (straw, reed, willow, etc.) bundled and linked into a whole by using rope, makes up the lack of the “entity” material for bank protection and played a huge role in several thousand years of flood control history. However, this structure mainly made of firewood has a fatal shortcoming, which is perishable, causing a hidden danger to bund engineering. In addition, it has light specific gravity, is easily washed away, and needs to cut down many trees, not in line with the philosophy of environmental protection.

With the development of science and technology, new material and process for bank protection continue to emerge, nowadays the practical new material (or structure) for bank protection is dolosse and wang word twist heterosexual blocks, and tetrahedron with six sides water permeable frame, which is made of concrete, and their working principle is to reduce the flow rate of shore side by changing the flow state of water flow, in order to achieve the purpose of scour prevention. Their main drawback is high cost; in addition, relative to the “water permeable” scour prevention members bundled from natural materials such as firewood and stones, such as “broom” and so on, their effects of energy dissipation and scour prevention are not good enough.

### SUMMARY OF THE INVENTION

Aiming at the above-mentioned status of prior art, the objective of the present invention is to provide a bank protection structure with shape of hollow circular truncated cone, which is environmentally friendly, and has low energy dissipation and good effects of energy dissipation and scour prevention.

The bank protection structure with shape of hollow circular truncated cone of present invention is a hollow circular truncated cone of concrete material shaped by template pouring, and the diameter of the bottom surface of the circular truncated cone >the diameter of the top of the circular truncated cone.

To further enhance the effects of energy dissipation and scour prevention under the premise of be environmentally friendly and having low energy dissipation, the present invention may further takes one or more of the following measures:

1. Plugging concrete flat plates perpendicular to the curved surface of the circular truncated cone on the circumference surface of the hollow circular truncated cone, and it would be best that the flat plates are three and uniformly distributed.

2. The concrete selects bamboo reinforced concrete or reinforced concrete.

3. The thickness of the wall of hole of the hollow circular truncated cone and the thickness of the concrete flat plates select ≧5 cm.

As a practical application of the present invention, plug grooves may opened on the concrete flat plates from down to up, the concrete plates are plugged onto the wall of hole of the hollow circular truncated from up to down by the opening on the lower end of the plug groove, and the mouth of the plug groove is blocked off by concrete.

The size of the structure of present invention is determined according to the water flow conditions and construction conditions.

In order to achieve the purpose of scour prevention and bank protection, the present invention increases energy dissipation of local water flow of and weakens the ability of erosion of water flow through tearing, dispersing and stirring up water flow. Relative to the existing concrete “rod” structure which is water permeable and has is effects of energy dissipation and scour prevention, the structure of the present invention is a “surface” structure. The combination of surfaces with different directions can more effectively cut, split and stir up water flow than the “rod” structure, and thus has better effects of energy dissipation. On the other hand, the mechanical properties of the present invention itself is better, it is not likely to cause stress concentration and therefore not susceptible to damage. And the present invention has better stability in water, can not easily be washed away by water flow; the present invention also has a large overhead ratio, can save materials of production.

The core component of the structure of present invention is a hollow circular truncated cone. Under the situation of poor process conditions, it may be used alone and does not add concrete flat plates. But adding concrete flat plates has three benefits: \textcircled{1} enhancing the effect of energy dissipation; \textcircled{2} enhancing the stability of the structure in the water; \textcircled{3} increasing the overhead ratio to save the concrete material.

The present invention can be used in the river bank, lakeshore and coast protection, can be used for slope protection and foot care, mainly for foot care. It is generally put in for the group.

### MODE OF CARRYING OUT THE INVENTION

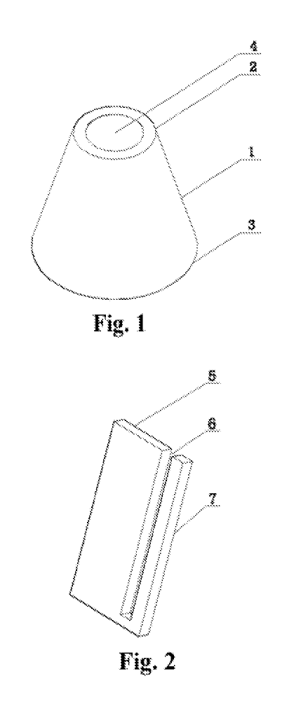

FIG. 1 is a schematic diagram of the hollow circular truncated cone of the present invention;

FIG. 2 is a schematic diagram of the concrete flat plates of the present invention;

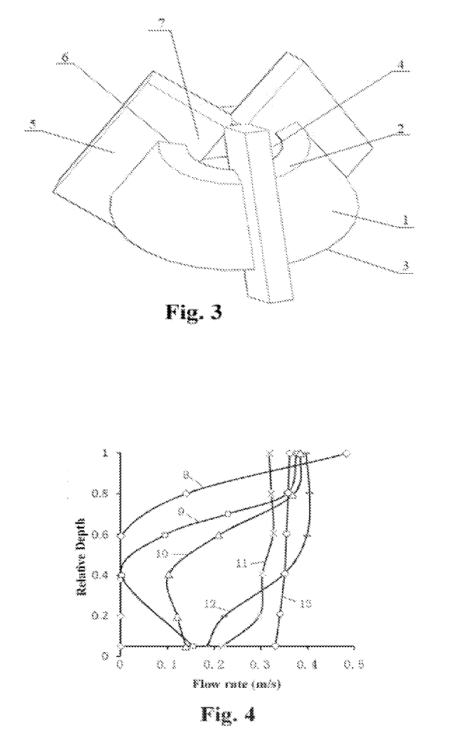

FIG. 3 is a schematic diagram of the integral construct of the structure of the present invention;

FIG. 4 is a vertical distribution map of the flow rate of measuring point 1;

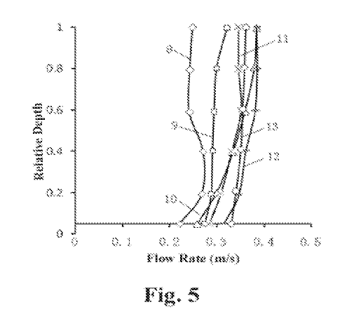

FIG. 5 is a vertical distribution map of the flow rate of measuring point 2.

Wherein, 1—circular truncated cone; 2—top surface of circular truncated cone; 3—bottom surface of circular truncated cone; 4—hollow; 5—concrete flat plate; 6—mouth of plug groove; 7—plug groove; 8—flow rate distribution when the circular truncated cone stands on end and its small mouth upward; 9—flow rate distribution when the circular truncated cone lies on the side and its small mouth approaches stream; 10—flow rate distribution when the circular truncated cone lies on the side and its big mouth approaches stream; 11—flow rate distribution of tetrahedron with six sides frame situation; 12—flow rate distribution of rock block situation; 13—flow rate distribution without barrier.

In the following, the production methods and working principle, etc. of the present invention will be further described taking the hollow circular truncated cone on which concrete flat plates are plugged as example.

1. Composition of the Structure and Processing Methods

The structure is assembled by a hollow circular truncated cone and three flat plates. The circular truncated cone and flat plates both take bamboo as skeleton, concrete as basic materials, poured separately, opened grooves from down to up in the middle of the flat plates, and when assembling, the three flat plates are symmetrically vertically inserted into the circular truncated cone and then the lower opening is blocked off by concrete. See FIG. 1˜FIG. 3.

2. Structural Size

The size of the structure may be enlarged or shrunk in proportion according to usage needs and construction conditions, but considering the strength requirements of concrete structure, it is suggested that the thickness of the hollow circular truncated cone and flat plates is at least 5 cm. If manually put in, it would be best that the weight is limited within 60 kg, at that time, it should be controlled that the diameter of the top surface of the circular truncated cone is not more than 36 cm, and the diameter of the bottom surface is not more than 54 cm.

3. Structural Features

Clever combination of the circular truncated cone and flat plates makes the structure have the following features:

\textcircled{1} Good Effects of Energy Dissipation and Scour Prevention

The hollow construct of the circular truncated cone and the overhead role of the flat plates make the structure have water permeability, at the same time of allowing water flow to permeate, cutting and separating water flow, destroying original water flow construct, motivating the dispersing of local water flow and energy loss, and thus make the scour ability of the water flow in protected area weaken greatly, to attain the effects of reducing scour and even prompting siltation.

\textcircled{2} Avoiding the Basis is Scoured

The structure has the effects of water permeability and energy dissipation, gives outlet to water flow, meanwhile abates the energy of water flow, avoiding the occurring of flow around, and thus solving the problem that the basis is scoured and meanwhile ensuring the safety of project itself.

\textcircled{3} Good Stability

Upper surface and lower surface of the circular truncated cone have different diameter, the circular truncated cone may pivot on site by the role of external force, but when rotating, interaction with surrounding water flow and other components can restrain the movement, making the structure restore stability quickly; the three flat plates form stable triangle framework, beneficial to the stability of the structure in moving water, and once silting of sediment starts to occur, the structure will be more stable.

\textcircled{4} Good Mechanical Property

The structure takes the clever combination of the surfaces of the circular truncated cone and the planes of the flat plates, reducing and can even avoid stress concentration, not susceptible to be damaged, and can save rebar.

\textcircled{5} Environmentally Friendly

On the one hand, the structure is made of concrete instead of trees, branches, etc. perishable organic materials in Chen Liu method, which is environmentally friendly; in the other hand, as a bank protection structure with high overhead rate, at the same time of scour prevention, it leaves big habitat space for aquatic life, beneficial to environmental protection.

\textcircled{4} Simple to Produce, Easy to Use, Low Cost.

4. Working Principle

The primary cause of river bank scouring is that the flow rate of local water flow is too big, and thus the best way of scour prevention and bank protection is to reduce the flow rate of scouring of water flow in scouring area. The combined structure of hollow circular truncated cone and plugboard destroys the water flow construct by effects of tearing and dispersing, dissipates energy of water flow, and reduces flow rate of river bottom or a coast, making scour-and-fill situation of protected area change, changing local scouring situation to not-scouring and even silting situation, and thus playing a part in energy dissipation and scour reduction, siltation promotion and bank protection.

Compared to existing various kinds of water permeable and energy dissipating structure, the present structure uses the combination of curve surfaces and planes instead of combination of rod pieces, the destructive effects to water flow is more obvious; the surfaces of the circular truncated cone and the planes of the flat plates are mutually orthogonal, so no matter which direction of water flow encountering the structure will then be fully torn and dispersed; after encountering the destroy of circular truncated cone and flat plates, great changes happen to the structure of water flow, torn and dispersed from a blast of water flow into vortex bodies or small jets with different sizes and different flow directions, and the inner energy dissipation of water flow increases, thus causing scour energy to abate greatly and meanwhile causing sediment transport capacity of water flow to reduce. The scour extent of original scoured area will weaken and even become siltation, and original silting area will silt more. Therefore the structure of the present invention plays a part in bank protection and foot care.

When the structure group meets toward top rush water flow, the water flow is not forced to fully change direction, while at the same time of water permeation, weakening the kinetic energy of the water flow step by step, changing flow state of local water flow, and slowing down the top rush effects of the main flow, the water flow tends to concentrate in the main groove, making the flow rate at lake shoal or slope toe reduce, and thus achieving the aim of reducing scour and prompting siltation, protecting bottom and safeguarding beach.

5. Effects Contrast Experiments

5.1 Energy Dissipation Experiments

\textcircled{1} Experiment Arrangements

To know about the effects of energy dissipation and decelerating, the pattern selects two components of rod blocks with similar volumes and tetrahedron with six sides frame, doing contrast experiments of water flow features with the structure of the present invention. The experiments are done in a glass water channel, mainly testing the vertical distribution of water flow after it flows through trier. To consider the influence of different ways of arrangement, the following three ways of arrangement are taken to the combined structure of hollow circular truncated cone and plugboard: \textcircled{1} The circular truncated cone stands on end and its small mouth upward; \textcircled{2} The circular truncated cone lies on the side and its big mouth approaches stream; \textcircled{3} The circular truncated cone lies on the side and its small mouth approaches stream.

Two measuring points are set behind the trier, at 5 cm (measuring point 1) and 60 cm (measuring point 2) downstream of the trier respectively. A pitot tube is used to measure the vertical distributions of flow rate on the measuring points respectively.

FIG. 4 and FIG. 5 are vertical distribution maps of flow rate of measuring point 1 and measuring point 2 respectively.

Experiment results indicate that:

a. Relative to the situation without barrier, the flow rate of water flow behind various barriers is reduced as a whole.

b. The reducing effects of the structure of the present invention on the flow rate of the water flow is stronger than the two objects used to compare.

c. Reducing effects of flow rate at the back near the structure is big, and the nearer the bottom the greater the reducing effects are.

d. If the way of arrangement of the structure of the present invention differs, the influence on flow rate changes also, in the present experiment, when the circular truncated cone stands on end and its small mouth upward, the effects of energy dissipation are bigger.

5.2 Scour-and-Fill Experiment

\textcircled{1} Experiment Arrangements

To know about the effects of scour reduction and siltation promotion of the structure of the present invention, two kinds of components of rod blocks with similar volumes and tetrahedron with six sides frame are selected, doing contrast experiments of scour-and-fill features on the same condition of water flow with the structure of the present invention.

\textcircled{2} Experiment Results and Analysis

It can be seen that obvious scour pits are shaped around the rock blocks in the experiment, the basis of the approach steam surfaces of the rock blocks is scoured, making the rock blocks dump toward one side, while there is no obvious water flow scouring phenomenon around the tetrahedron with six sides frame and the structure of the present invention, be stable. Throwing the structures in group, it can be seen that the combined structure of the hollow circular truncated cone and plugboard has better effects of siltation promotion than the tetrahedron with six sides frame, sediment silts behind the structure of the present invention in quantity, and extends to a certain range.

The experiment phenomena indicate that:

a. When entity regulating structure (rod block) is used, the water flow shapes flow around and spiral flow about the entity, causing local scour and resulting in the project itself instability and be destroyed; while if water permeable regulating structure (tetrahedron with six sides frame, the structure of the present invention) is used, allowing the water flow to permeate and dissipate water flow energy, the basis can be avoided to be scoured.

b. Relative to the tetrahedron with six sides frame group, the structure of the present invention has better effects of energy dissipation and siltation promotion, the changes of the water flow before and after flowing through the tetrahedron with six sides frame group are small, only the water flow near the rod pieces is influenced to some extent, and obvious sediment siltation phenomenon is not seen behind the structure group. However, the water flow is torn, dispersed and picked away when it goes through the structure of the present invention, big changes happens to its structure, shaping vortex inside and energy is cost, the water flow becomes smooth after undergoing the energy dissipation step by step of the structure group and the flow rate reduces, making siltation happen to the sediment in a certain range inner and behind the structure group.

Thus it can be seen that, relative to entity components, the structure of the present invention itself is stable, water permeable and energy dissipated, and thus the basis can be avoided to be scoured; relative to tetrahedron with six sides frame in the permeable structures, the structure of the present invention adopts combination of surfaces instead of combination of rods, the destructive effects to the water flow obviously enhanced, the effects of energy dissipation and siltation promotion are more remarkable, and the mechanical property is good, not easy to be destroyed.

1. A bank protection structure with shape of hollow circular truncated cone, characterized in that said bank protection structure consists of a hollow circular truncated cone and concrete flat plates; the circular truncated cone, being made of concrete materials, shaped by template pouring, and the diameter of bottom surface of the circular truncated cone being bigger than the diameter of top surface of the circular truncated cone; said concrete flat plates, perpendicular to curved surface of the circular truncated cone, being plugged on the circumference surface of the circular truncated cone.

2. The bank protection structure according to claim 1, characterized in that, said concrete flat plates have plug grooves which allow said concrete flat plates to be plugged by the wall of the circular truncated cone from up to down, then mouth of the plug groove being sealed by concrete.

3. The bank protection structure according to claim 1, characterized in that, said concrete is bamboo reinforced concrete or reinforced concrete.

4. The bank protection structure according to claim 1, characterized in that, there are three concrete flat plates being plugged by the circular truncated cone, and said three concrete flat plates being evenly distributed on the circumference surface of the circular truncated cone.

5. The bank protection structure according to claim 1, characterized in that, the thickness of the wall of the circular truncated cone and the thickness of the concrete flat plates both equal or are bigger than 5 cm.

6. The bank protection structure according to claim 2, characterized in that, said concrete is bamboo reinforced concrete or reinforced concrete.

7. The bank protection structure according to claim 2, characterized in that, there are three concrete flat plates being plugged by the circular truncated cone, and said three concrete flat plates being evenly distributed on the circumference surface of the circular truncated cone.

8. The bank protection structure according to claim 2, characterized in that, the thickness of the wall of the circular truncated cone and the thickness of the concrete flat plates both equal or are bigger than 5 cm.

9. An energy dissipation structure consists of a hollow circular truncated cone and flat plates, said flat plates, perpendicular to curved surface of said circular truncated cone, being adhered to inside or outside of the wall of said circular truncated cone; said inside and outside flat plates being connected by small flat plates at the top and bottom of said circular truncated cone.

10. The energy dissipation structure according to claim 9, said energy dissipation structure is made of rubber, plastic or similar materials.

11. The energy dissipation structure according to claim 10, said energy dissipation structures are utilized as wave-reducing devices and/or bumpers of boats.
